(19) United States
(12) Patent Application Publication
(10) Pub. No.: US 2005/0181173 A1
(43) Pub. Date: Aug. 18, 2005

(54) Angled ribs for plastic part attachment for vehicles

(76) Inventor: Stephan M. Hermann, Cullman, AL (US)

Correspondence Address: MCGUIREWOODS, LLP, 1750 TYSONS BLVD, SUITE 1800, MCLEAN, VA, 22102, US

(21) Appl. No.: 11/011,594

(22) Filed: Dec. 15, 2004

Related U.S. Application Data
(60) Provisional application No. 60/529,590, filed on Dec. 16, 2003.

(51) Int. Cl. B22C 9/02; B32B 31/00

(52) U.S. Cl. 428/119; 428/343; 264/236; 264/331.11; 156/87; 156/91

(57) ABSTRACT

Molded plastic parts particularly adapted for use as vehicle body moldings are disclosed. The moldings have one or more series of angled ribs facilitating secure attachment of the molding to an interior or exterior vehicle surface by adhesive material, such as, but not limited to, double-sided adhesive tape. The angled ribs also act as a vent to drain any water or other material collected in channels formed between the ribs, which helps improve any subsequent painting of the molding. Methods for manufacturing such vehicle parts are also disclosed.

### CROSS-REFERENCE TO RELATED APPLICATIONS

This application claims priority to provisional application Ser. No. 60/529,590, filed in the United States Patent and Trademark Office on Dec. 16, 2003, the disclosure of which is herein incorporated by reference in its entirety.

### BACKGROUND OF THE INVENTION

1. Field of the Invention

The invention relates generally to molded plastic parts adapted to be adhesively attached to the interior or exterior of vehicles and, more particularly, to molded plastic parts particularly suited for use as body moldings for vehicles.

2. Background Description

Various types of plastic parts are commonly used on cars, trucks and other types of motor sport or recreational vehicles to produce vehicle designs that are visually appealing and/or prevent damage to the vehicle finish, or for other known purposes. In particular, body moldings are molded plastic parts, usually elongate in shape, which are affixed to the exterior surface of a door, quarter panel, or other body part typically made of sheet metal. Mounting of the body molding to a vehicle has been accomplished using a mechanical connection such as plastic clips and/or a double-sided adhesive tape. In one known design, the plastic clips are of the type having a base portion that attaches to a receptacle formed on the inner surface of the molding, and a protruding portion that lockably inserts within a corresponding receptacle formed in the sheet metal of a vehicle body part.

Although use of clips often provides sufficient structural support for the body molding, there are disadvantages to such an attachment. For example, a gap typically appears between the top edge of the body molding and the surface of the vehicle body part to which it is attached. The gap results from the plastic clips being attached to the body side molding at positions distal from its edges. To create a more visually appealing appearance, and/or provide a more watertight attachment, a strip of double-sided tape has been placed along the top edge of the body molding before it is snapped into place. An example of one such conventional part design adapted to be attached by clips and double-sided tape is shown in FIGS. 2-4. The double-sided tape, which is either a long thin straight length of tape or shaped die-cuts of tape, fills the gap between the top edge of the body molding and the surface of the vehicle body part. In most instances, tape is not applied to the bottom edge of the body molding because this bottom edge is not typically visible to a person viewing the vehicle. However, attachment designs using two rows of adhesive tape, and no clips, such as those shown in FIGS. 5-6, are also known.

Various molding processes known to persons of ordinary skill in the art have been used to mold plastic parts suitable for use as such body moldings although injection molding is very common. Ideally, the plastic part would have a solid area to which the tape is applied on the back or non-visual side of the component. However, molding such parts with a thickened tape attachment surfaces would provide sink marks of the relatively thick solid area on the side of the part that is visible when the body side molding is attached to a vehicle body part. (The visible side may be referred to as the “A” surface.) The sink marks are caused by bleedthrough, which is a known phenomenon that occurs when a molded plastic part has solid areas of substantially different thickness. Typically, body moldings are not cast in a uniform thickness throughout to reduce the weight of the finished product as well as its manufacturing cost. Thus, for example, if a body molding were cast to include a hollow interior area and a solid strip along an inside top edge thereof for receiving a piece of double-sided tape, one or more outlines of the solid strip or sink marks would “bleedthrough” and become visible on the “A” surface. Thus, the “A” surface would be marred by the outlines of underlying support structures. To prevent bleedthrough, the tape adhesion area conventionally has been formed of a series of thin, substantially parallel ribs, each separated by a small gap.

In such conventional designs, such as those shown in FIGS. 2-6, these ribs typically extend from one end of the body molding to the other substantially parallel to the longitudinal axis of the molding and its bottom edges, and terminate just short of the edges of the ends. Thus, conventional tape-adhesion ribs form channels that tend to have closed ends. Applicant discovered that various problems are associated with such prior art designs typified by parallel tape-adhesion ribs. For example, when the body molding is power washed prior to painting, water may collect in the gaps between the ribs despite subsequent heating. Later, during a painting process, the collected water tends to drip out, which causes blemishes in the finish and causes unsuitable parts. Thus, there is a need for an improved attachment for a vehicle body molding or similar parts that provides increased adhesion and/or lower paint defects.

### SUMMARY OF THE INVENTION

The invention meets the foregoing needs and avoids the drawbacks and disadvantages of the prior art by providing a plastic vehicle part having one or more angled projections configured to receive an adhesive material that is disposed along an interior attachment area. The angled projections may be generally parallel to each other, but are preferably arranged at an angle relative to the edges and/or longitudinal axis of the part, and/or a longitudinal rib to which it may be attached. In particular, embodiments made in accordance with the invention provide increased adhesive forces and/or lower paint defects in a unique and superior manner when contrasted with the more conventional methods used by other molded plastic part suppliers.

Exemplary embodiments of the invention include the use of one or more series of angled projections, alone or in combination with longitudinal ribs, to increase the adhesion surface area compared to conventional designs. In particular, angled projections of the invention preferably provide a greater density of ribs per unit surface area than conventional longitudinal ribs that occupy an area of equal size, thereby providing for a securer attachment. Additionally, unlike conventional longitudinal ribs, the angled projections may form a channel having an open end portion that permits water or other material collected in the gaps between the ribs to drain away, and then evaporate during the drying process prior to a finishing step, such as painting. As noted above and in the illustrated embodiments, the angled projections may be thin ribs, similar in size and shape as longitudinal ribs of conventional design, and may be used alone or in combination with longitudinal ribs. If angled ribs are used alone, areas in which the angled ribs are formed may include ribs positioned at the same or different angles, and separated by the same or different spacing.

According to one aspect, the invention may be embodied in a body molding adapted to be adhesively secured to a vehicle. The body molding may include a body having a longitudinal axis, top and bottom edges, front and back ends, and opposing surfaces. A first adhesive receiving area may be provided on one of the opposing surfaces. The first adhesive receiving area may include a first plurality of spaced projections configured to receive an adhesive material. The projections may be angled relative to at least one of the longitudinal axis, the top edge and the bottom edge. A second adhesive receiving area may be provided on the one opposing surface. The second adhesive receiving area may include a second plurality of spaced projections configured to receive adhesive material. The spaced projections may define at least one channel therebetween including an open end allowing fluid trapped in the at least one channel to escape. Moreover, the first plurality of spaced projections and said second plurality of spaced projections may have different spacings and/or orientations such that the densities of projections per unit surface area of the first and second plurality of projections differ. At least one of said densities may be selected to enhance the adhesion of adhesive material, typically double-sided adhesive tape, to the projections. At least some of the first plurality of projections may be angled relative to the second projections. Additionally, the second adhesive receiving area may be adjacent to the first adhesive receiving area, such as by providing the first area along the top edge of the part and the second area at the front of the part. In this case, a mechanical connection such as a locking member may be used to assist the tape in attaching the molding to the vehicle. Alternatively, the first and second adhesive receiving areas may be located adjacent the top and bottom edges of the molded part, and without any mechanical connection. The projections in the first and second adhesion receiving areas may comprise a combination of longitudinal and angled projections or may be all angled projections of uniform or variable spacing and size. A third adhesion area having similar projections may also be provided, if desired, at the front or back end of the one opposed surface. The projections of adhesive receiving areas and the body may be integrally formed by the same process.

According to another aspect of the invention, a molded vehicle part is provided having a longitudinal axis, opposing surfaces and perimeter edges, and a first adhesion area provided on one of said opposing surfaces for connection to a support surface. The first adhesion area may include a first plurality of spaced projections. The projections may be angled relative to at least one of the longitudinal axis and one of the perimeter edges of the molded vehicle part. A second adhesion area may be provided on said one opposing surface for connection to a support surface. The second adhesion area may include a second plurality of spaced projections. Both adhesion areas may be configured to receive adhesive material, such as double-sided adhesive tape. If it is desired to supplement the adhesive connection forces with a mechanical attachment, the molded vehicle part may include a receptacle formed on the one opposing surface. A locking member, such as a clip, may have a base portion attached to the receptacle and a protrusion engageable in a corresponding receptacle formed in the support surface of a vehicle to which the part is to be attached.

According to yet another aspect of the invention, a method is provided for manufacturing a plastic vehicle part adapted to receive adhesive material for attaching the part to a surface of the vehicle. The method may include providing a mold capable of producing a plastic vehicle part. The plastic vehicle part may have a body having a longitudinal axis, top and bottom edges, front and back ends, and opposing surfaces. The plastic vehicle part may also include a first adhesion area having a first plurality of spaced projections configured to receive adhesive material. The projections may be angled relative to at least one of the longitudinal axis, the top edge, and the bottom edge. The mold is filled with a plastic material, which is then cured to form the plastic vehicle part. After the part is removed from the mold, it may be washed and fluid trapped between the spaced projections may be vented before, during, or after a heating step, which typically occurs before any finishing treatments such as paint are applied. The part may then be adhesively connected to a support surface of the vehicle, with or without a supplemental mechanical connection. The support surface may be an interior or exterior surface, which is typically made from sheet metal, glass, plastic, or similar materials.

Embodiments of the invention will work equally well with virtually any type of molded part, whether formed of plastic, resin, metal, or other moldable material. While the invention was developed to improve the attachment and design of vehicle moldings, the skilled artisan will recognize that the invention may be used in any number of applications or environments, particularly where plastic parts are to be attached adhesively to sheet metal, glass, plastic, or similar surfaces. Thus, the invention is not limited exclusively to plastic body moldings for vehicles.

Additional features, advantages and embodiments of the invention may be set forth in the following detailed description, drawings, and claims, including methods of using the invention to reduce paint defects and/or to increase adhesion forces. Although numerous implementations and examples of the invention are set forth in the patent including in this “Summary of Invention” section, the examples and implementations are not intended to limit the scope of the invention.

### BRIEF DESCRIPTION OF THE DRAWINGS

The accompanying drawings, which are included to provide a further understanding of the invention and are incorporated in and constitute part of this specification, illustrate preferred embodiments of the invention, and together with the detailed description, serve to explain principles of the invention. In the drawings:

FIG. 1 is a perspective view showing body side moldings attached to the door and quarter panel portions of a vehicle;

FIG. 2A is a plan view of a conventional body side molding having a series of thin, longitudinal ribs extending generally parallel to each other along a top edge of the molding;

FIG. 2B is an enlarged, partial plan view of the molding shown in FIG. 2A;

FIG. 3 is a sectional view taken along the line A-A in FIG. 2 illustrating the longitudinal ribs in cross section;

FIG. 4 is an enlarged side view of a conventional plastic clip used to attach the body side molding of FIG. 2 to a body part of a vehicle;

FIG. 5 is a plan view of another conventional body side molding having a series of longitudinal ribs extending parallel to each other along both a top edge and bottom edge thereof, which does not use any clip attachments;

FIG. 6 is a sectional view taken along the line A-A in FIG. 5 showing a cross section of the top and bottom series of ribs;

FIG. 7 is a plan view of a first embodiment of a body molding constructed according to the principles of the invention having two series of angled ribs formed along the top and front edges, respectively, of the underside of the molding;

FIG. 8 is a cross-sectional view of the body molding of FIG. 7, taken along the line 8-8, showing the angled ribs at the top edge of the molding, as well schematically illustrating adhesive attaching the molding to a supporting surface;

FIG. 9 is a plan view of a second embodiment of a body molding constructed according to the principles of the invention having three series of angled ribs formed along the top, front, and bottom edges thereof, respectively;

FIG. 10 is an end view of the body molding of FIG. 9, showing the angled ribs at the top and bottom edges of the molding;

FIG. 11 is a plan view of a third embodiment of a body molding constructed according to the principles of the invention having a series of short angled ribs formed integrally in combination with longitudinal ribs along the top and bottom edges of the molding;

FIG. 12 is a sectional view taken along the line A-A in FIG. 11 showing the longitudinal ribs at the top and bottom edges of the molding; and

FIG. 13 is a perspective view of an end of the body molding of FIG. 11 showing the interface between the angled ribs and the longitudinal ribs at the top and bottom of the molding.

### DETAILED DESCRIPTION OF

### EMBODIMENTS OF THE INVENTION

The figures herein illustrate various embodiments of the invention having one or more angled ribs, alone or in combination with one or more longitudinal ribs. Embodiments of the invention are configured to provide angled ribs on the attachment side of a body molding or other type of molded plastic part, which is typically not visible during its intended use. As used herein, body molding is broadly construed to mean any plastic part to be attached to any of the interior or exterior surfaces of a vehicle. The angled ribs of the invention provide increased surface area for adhesion and may also result in reduced painting defects.

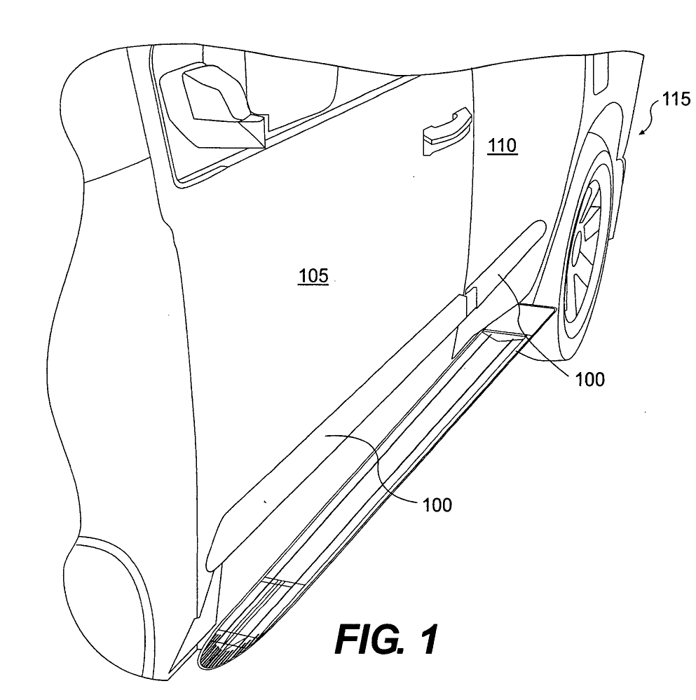

FIG. 1 is a perspective view of a plastic body side molding 100 showing its intended use attached to the door 105 and quarter panel 110 of a vehicle 115 to provide protection and/or a visually pleasing appearance for the body of the vehicle. The molding 100 may be attached to other parts or at in positions on the vehicle, as would be recognized by a skilled artisan. The types of vehicles to which the moldings of the invention may be attached include cars, trucks, SUVs, recreational vehicles and other types of motorized or non-motorized devices in which protection against dinging, scrapes, and damage to the exterior finish of the device is desired. Thus, while the invention is particularly adapted to attach protective body moldings to the sheet metal, glass, or plastic surfaces of vehicles, it may be applicable for any use in which a plastic part needs to be attached to these or similar materials.

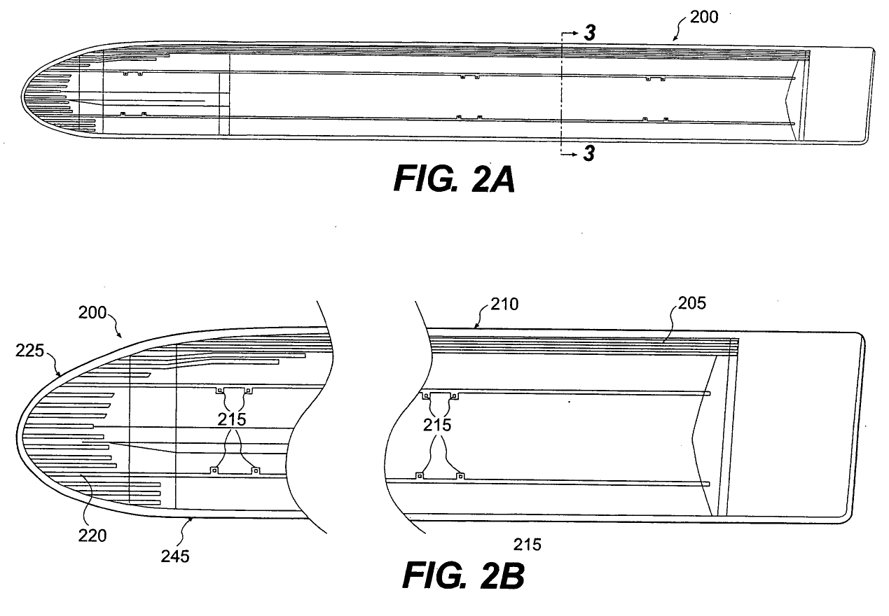

FIGS. 2-6 illustrate examples of two types of conventional body side moldings. FIGS. 2A and 2B are plan views of a conventional body side molding 200 showing the underside or back surface of the molding. FIG. 2B is an expanded view of the body side molding 200 shown in FIG. 2A. Referring to FIG. 2B, the molding 200 is formed with a series of thin longitudinal, closely spaced ribs 205 extending upwardly from the underside of the molding parallel to each other along atop edge 210 thereof. In this particular design, the longitudinal ribs 205 were approximately 0.7 mm wide and approximately 7.0 mm high, with gaps of approximately 1.6 mm therebetween. The ribs form a tape-adhesion area onto which double-sided tape was applied along the length and width of the longitudinal ribs 205 to attach the molding to the vehicle surface. A shaped die-cut piece of tape was applied over one or more of the larger, parallel support ribs 220 formed at one end 225 of the body side molding 200.

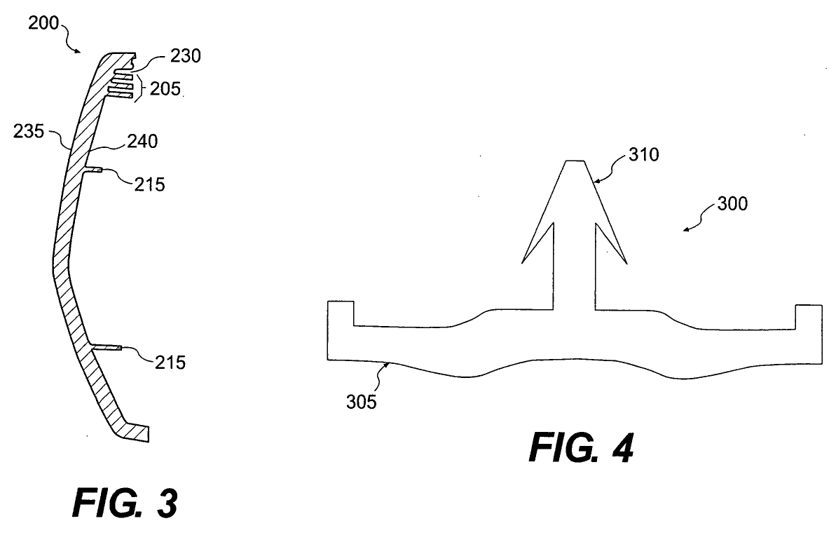

FIG. 3 is a sectional view taken along the line 3-3 in FIG. 2, illustrating the gaps 230 that separate the longitudinal ribs 205 from each other, thereby forming channels within the ribs in which water or other fluids may be trapped. FIG. 3 also illustrates the concave shape of the molding defined by the “A” surface 235 and the back surface 240 of the body side molding 200. The concave shape has been used to reduce weight and manufacturing costs. One or more receptacles are formed on the back surface 240 between projections 215 to retain a clip 300, shown in FIG. 4, used to attach the center areas of the molding to the vehicle. As mentioned above, the “A” surface is an outer surface of the body side molding 200 that is visible when the body side molding 200 is attached to a body part of a vehicle, and is typically painted or treated to provide an attractive or decorative finish.

FIG. 4 is a side view of a plastic clip 300 having a base 305 and a projection 310 used to attach the body side molding 200 of FIG. 2 to a body part of a vehicle. Mounting of the body side molding 200 to the vehicle 115 is accomplished in this design by using plastic clips 300 (shown in FIG. 3) and double-sided adhesive tape. The base 305 of each plastic clip 300 snaps into one of three clip receptacles 215 formed on longitudinally spaced areas at the center of the back surface 240 of the body side molding 200. A strip of double-sided adhesive tape (not shown), having approximately the same width and length as the longitudinal ribs 205 is adhered to the molding by aligning and pressing the tape into contact with the longitudinal ribs 205. The body side molding 200 is then positioned proximate a vehicle body part such that the projection portions 310 of the clips 300 align with corresponding projection receptacles (not shown) that are formed in the vehicle body part. Pressure is then applied to lockably engage the projection portions 310 of the clips 300 within the corresponding projection receptacles, and to adhere the double-sided adhesive tape to the vehicle body part.

Use of clips 300 provides sufficient structural support for the body side molding 100. However, if the double-sided tape were not applied to the longitudinal ribs 205, a gap would appear between the top edge 210 of the body side molding and the surface of the vehicle body part to which it is clipped. Instead, the double-sided tape fills the gap to create a visually pleasing appearance and a more watertight connection in use. In this particular design, no tape was applied along the bottom edge 245 of the body side molding 200.

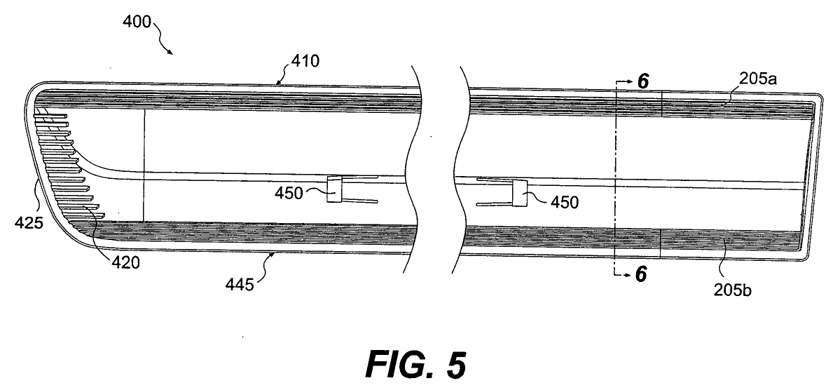

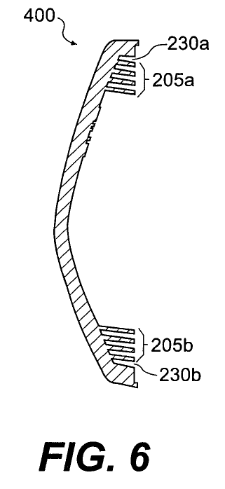

Referring to the design shown in FIGS. 5 and 6, FIG. 5 is a plan view showing the underside of another conventional body side molding 400 formed to have two series of thin, longitudinal ribs 205a. The width, height, and spacing of the longitudinal ribs in this design were approximately the same values as the respective values of the design shown in FIGS. 2-4. The first set of ribs extends parallel to each other along both a top edge 410 of the molding 400, while a second set of longitudinal ribs 205b extends parallel to each other along a bottom edge 445 thereof. A plurality of longitudinal structural ribs 420 are formed at a front end 425 of that body side molding. No attachment clip is used in this design. Holders 450 (shown schematically in FIG. 5) extend upwardly from the underside of the molding 400 and have openings provided for hanging the body side molding 400 during power washing and painting.

FIG. 6 is a sectional view of the body side molding 400 of FIG. 5, taken along the line 6-6, and illustrating gaps 230a formed between the longitudinal ribs 205a, gaps 230b formed between longitudinal ribs 205b, and the concave cross-sectional shape of the body side molding 400. In this design, water or other material may become trapped in the channels formed by adjacent ribs at 205a and 205b.

In the body side molding 400 of FIG. 5, two adhesion areas (e.g., the top surfaces of longitudinal ribs 205a and longitudinal ribs 205b) are used to attach the body side molding 400 to a vehicle body part during use. Thus, in this design double-sided adhesive tape was applied along a length and width of the longitudinal ribs 205a and along a length and width of the longitudinal ribs 205b. Optionally a shaped, die-cut section of double-sided tape was applied over one or more of the support ribs 420 formed at one end 425 of the body side molding 400, to attach the molding to a vehicle.

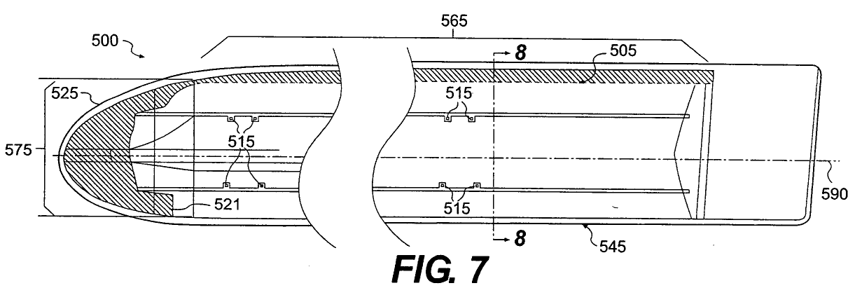

Several embodiments of a body molding constructed in accordance with principles of the invention are described with reference to FIGS. 7-13. While the Figures show the invention implemented in a body side molding, the principles of the invention are applicable to any plastic part to be adhesively connected to a vehicle surface. FIG. 7 is a plan view of a body molding 500 showing the underside of the molding. Molding 500 includes one or more series of angled ribs 505, forming a first adhesion area 565, and ribs 521, forming a second adhesion area 575. Ribs 505 are disposed along a top edge 510 and ribs 521 along a front edge 525 of the underside of the molding. As described in more detail herein, ribs 505 and 521 are preferably integrally formed with the molding. Unlike the conventional designs shown above, the angled ribs 505 are angled relative to the longitudinal axis 590 and top edge 510 of the molding and form the adhesion area 565, which has a greater surface area, and therefore provides for increased adhesion, than the conventional designs with longitudinal ribs. The angled nature of the ribs also acts as a vent or relief preventing water from being trapped between the ribs, as was the case with the prior longitudinal rib designs, which could lead to defects during painting and finishing.

The precise size, shape, height and spacing of the angled ribs will be determined in accordance with the specific customer requirements with respect to desired tape adhesion characteristics, limitations on molding, processes and tooling, and other factors readily known to is the skilled artisans. The denser or closer the ribs are placed together, the greater the surface area and adhesion force that will be provided, but the harder it will be to produce tooling capable of molding the part. The further apart the angled ribs are spaced the less area and adhesion force will be provided. Thus, the spacing between the ribs for any particular design will likely be guided by the desired adhesion force and limitations on current molding toolings and processes.

In general, given current design or production constraints, an exemplary range for both the rib thickness and rib spacing values is approximately 0.1 mm to approximately 4-5 mm. The minimum rib thickness and rib spacing values are each bounded by the tooling or production technology currently available, while the maximum thickness is bounded by the material properties of the molded vehicle part and the desire to avoid sink marks. If the ribs are made too thick, bleedthrough may result in undesirable sink marks. The maximum spacing between the ribs is limited only by the amount of adhesion force desired and/or geometry required for a particular application. The rib height may be proportional to the rib thickness, and is bounded only by the geometry required for the molded plastic part to satisfy a given application or requirement. As design and production technology advance, it is anticipated that the exemplary ranges of the invention will change. Accordingly, the invention is not to be construed as being limited to the exemplary ranges mentioned above, and may include values outside these ranges that are determined, or made possible, by current or future technological advancements.

The angle at which the ribs are placed relative to the longitudinal axis, or to a top or bottom edge, may also vary based upon routine design considerations, including molding limitations and other factors known in the art. In general, the angle should be great enough to permit water to freely drain from the spaces between the ribs. The ribs preferably are generally parallel to each other, although other designs are possible as the skilled artisan will recognize, such as alternating angles and the like.

A suitable adhesive material, such as, but not limited to, double-sided-adhesive tape commercially available from 3M Corporation, may be applied along a length and width of the angled ribs 505 to attach the molding to a vehicle or other surface. The adhesive material may also be applied over the second adhesion area 575, which includes the angled ribs 521 formed at an end 525 of the improved body molding 500. One or more clip receptacles 515 may be provided on a back surface of the body molding 500.

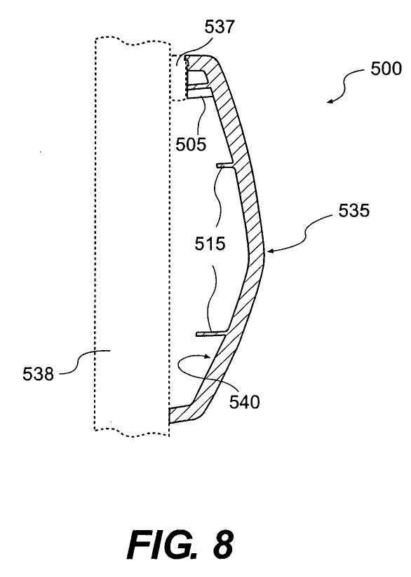

FIG. 8 is a cross-sectional view of the improved body molding 500 of FIG. 7, taken along the lines 8-8 illustrating the concave shape defined by an “A” surface 535 and the back surface 540 of the body molding 500. Again, one or more clip receptacles 515 may be formed in on the back surface 540. The “A” surface is an outer surface of the improved body molding 500 that is visible when the improved body molding 500 is attached to a body part of a vehicle and will be finished by painting and for other treatments. To reduce weight and manufacturing costs, the improved body molding 500 preferably has a concave cross-sectional shape similar to that illustrated in FIG. 8, but other shapes may be used as well.

The mounting of the body molding 500 may be accomplished using conventional an adhesive material, such as double-sided adhesive tape, as well as plastic clips 300 (such as shown in FIG. 3). Illustratively, a strip of double-sided adhesive tape, having approximately the same width and length as the adhesion area 565 is applied onto the angled ribs 505, and optionally onto ribs 521 of adhesion area 575, in a conventional manner. The base 305 of each plastic clip 300 snaps into the corresponding clip receptacle 515 formed on the back surface 540 of the body molding 500. The body molding 500 is then positioned proximate a vehicle body part such that the projection portions 310 of the clips 300 align with corresponding projection receptacles (not shown) that are formed in the vehicle body part. Pressure is then applied to lockably engage the projection portions 310 of the clips 300 within the corresponding projection receptacles, and to adhere the double-sided adhesive tape to the vehicle body part.

An adhesive material, such as, but not limited to, double-sided tape 537 shown schematically at a greatly enlarged scale in FIG. 8, is adhered on one side to angled ribs 505, and on the opposing side, to a support surface 538 of a vehicle. The support surface 538, which includes interior and exterior vehicle surfaces, may be made from glass, plastic, fiberglass, metal, or any other material suitable for forming a vehicle part and adhering the part thereto. While FIG. 1 shows that the improved body molding 500 may be adhered to an exterior side surface of a vehicle, the skilled artisan will appreciate that moldings of the invention may be placed on other interior or exterior locations of the vehicle, and the invention may be embodied in other interior or exterior plastic parts besides side moldings.

Any of various types of adhesive materials known to a skilled artisan, including glues or types of double-sided adhesive tape custom-made or commercially available from a manufacturer such as 3M Corporation, may be used, provided the adhesive material has sufficient material characteristics (UV resistance, desired working and curing times, etc.) and sufficient adhesion to permanently adhere the improved body molding 500 to an exterior or interior surface of a vehicle. Thus, the adhesive material may include liquid and semi-liquid (e.g., viscous) materials, or may include a band of adhesive formed on opposing sides of a carrier material.

As discussed above, the gripping force of the adhesive material is generally proportional to the surface area of the ribs contacted. This, combined with the overall weight of the improved body molding 500, intended application (off-road use or highway use, etc.), and other factors, will drive the amount of adhesive material needed for a particular application. Thus, the type of adhesive material, the number, size, spacing, orientation, and location of the angled ribs 505 (and/or any longitudinal ribs) will vary for each particular application. However, such parameters are easily determined by persons of ordinary skill in the art using known design considerations.

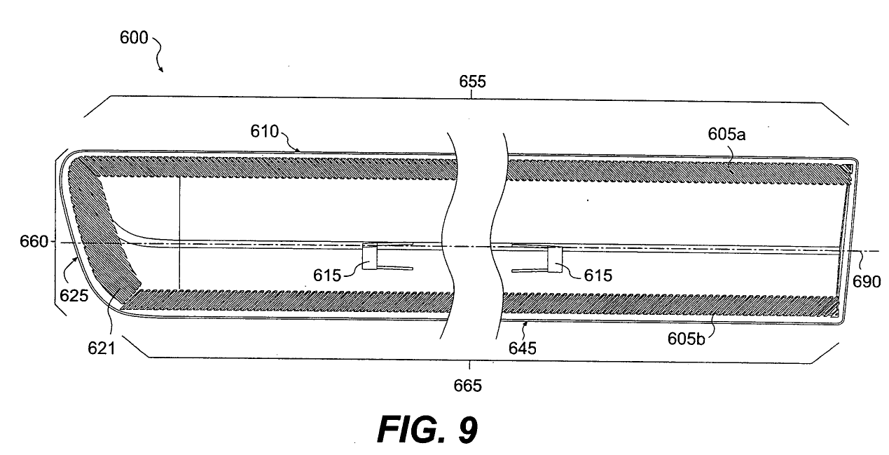

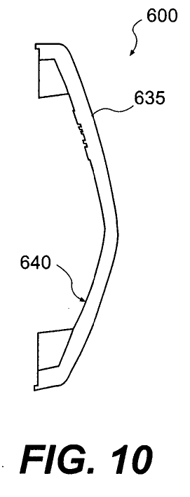

FIG. 9 is a plan view of second embodiment of a body molding 600 of the invention having a first series of angled ribs 605a formed along a top edge 610, a second series of angled ribs 605b formed along a bottom edge 645, and a third set of angled ribs 521 formed along a front edge 625 thereof. In this embodiment, the spacing and orientation of the angled ribs 605a and 605b are uniform, relative to the longitudinal axis 690 of the molding, and the spacing and orientation of the front series of ribs 521 vary from that of the upper and lower ribs 505a and 505b. However, as discussed above, other configurations are possible, depending on the type of application in which the body molding 600 is to be used, and the requirements to be met, as will be readily apparent to persons of ordinary skill in the art. FIG. 10 is an end view of the body molding 600 of FIG. 9 illustrating an exemplary cross-sectional concave shape of the body molding 600, as well as an “A” surface 635 and a back surface 640 of the body molding 600, and some of the angled ribs.

Referring to FIGS. 9 and 10, the body molding 600 does not use plastic attachment clips. However, one or more holders 615 may be included for hanging the body molding 600 during power washing and painting, as is known in the art. In the body molding 600, the plastic clips have been replaced with three adhesion areas 655, 660, 665 corresponding to angled ribs 605a, 605b, and 621, respectively.

The body molding 600 may be mounted to a vehicle body part by applying double-sided 15 adhesive tape, or other suitable adhesive material, to each of the three adhesion areas 655, 660, 665, corresponding to the surface areas of the angled ribs 605a, 605b, and 621; positioning the improved body molding 600 proximate the vehicle body part; and pressing the improved body molding 600 onto the surface of the vehicle body part until the adhesive tape adheres thereto. While use of three adhesion areas 655, 660, 665 helps ensure that the body molding 600 remains attached to a vehicle body part or similar surface during use, the front adhesion area 660 may be eliminated in whole or part, and/or the angled ribs 605a and 605b may consist of a series of longitudinally spaced sections forming spaced adhesion areas, rather than a continuous set of ribs provided along the entire top and bottom edges, depending upon the particular application.

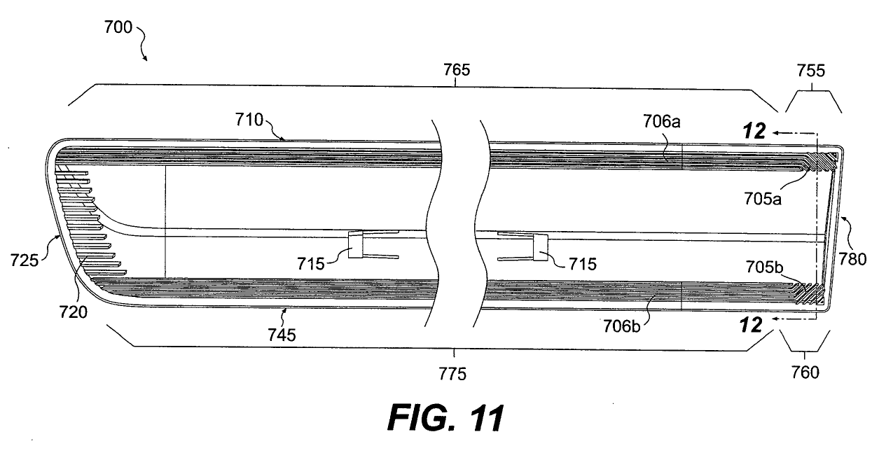

FIG. 11 is a plan view of third embodiment of a body molding 700 of the invention having first set of angled ribs 705a formed in combination with one or more longitudinal ribs 706a disposed along a top edge 710 thereof, and a second set of angled ribs 705b formed in combination with one or more longitudinal ribs 706b along a bottom edge 745 thereof. Longitudinal support ribs 720 may be provided at front 725 of the molding. The size, spacing, and shape of ribs 706a and 706b may be similar to that of ribs 205, 205a, or 205b, while the size, shape, and spacing of ribs 705a and 705b may be similar to that of ribs 505, 605a or 605b.

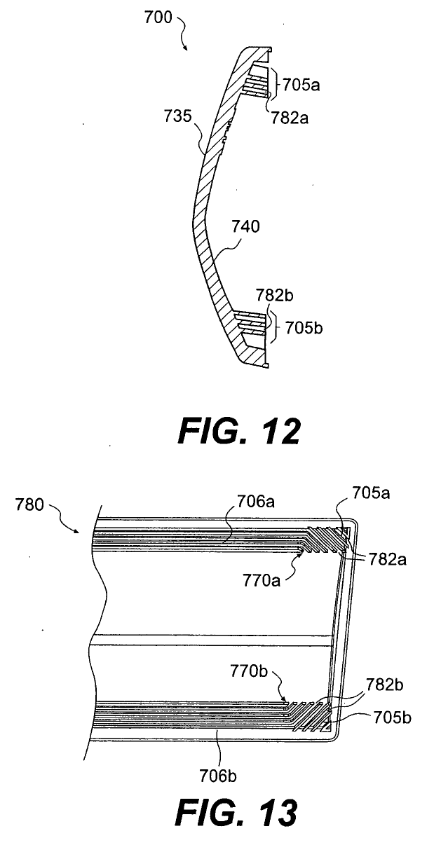

FIG. 12 is a sectional view taken along the line 12-12 in FIG. 11 illustrating the preferred concave shape of the molding, the placement of the longitudinal ribs 706a and 706b, as well as an “A” surface 735 and a back surface 740 of the improved body molding 700. FIG. 12 also illustrates the spacing (e.g., gaps) 782a between the angled ribs 705a, and the spacing 782b between the angled ribs 705b.

FIG. 13 is a perspective view of the underside of the body molding 700 at an end 780 and shows the interface 770a between the angled ribs 705a and the longitudinal ribs 706a, as well as an interface 770b between the angled ribs 705b and the longitudinal ribs 706b which are preferably integrally formed together. It will be appreciated by persons of ordinary skill in the art that periodic repetitions of angled ribs 705a and longitudinal ribs 706a may be made along the length of the body molding as well as providing areas where there are no ribs of any kind. Similar configurations are possible for the angled ribs 705b and the longitudinal ribs 706b. Also illustrated in this figure are the spacings 782a disposed along a perimeter edge of the angled ribs 705a and the spacings 782b disposed along a perimeter edge of the angled ribs 705b. The openings at the end of the spacings 782a and 782b provide a path for water or other material trapped between the longitudinal ribs 706a and 706b and/or between the angled ribs 705a and 705b to drain out from between the ribs.

Providing angled ribs at desired locations along the molding, such as shown in FIGS. 11-13, serves to increase the adhesion surface areas 755, 760, per given unit area compared to the surface areas 765, 775, where only longitudinal ribs are provided, and is a desirable way of increasing adhesion force at given locations. Although not shown, it will be appreciated by persons of ordinary skill in the art, that other rib variations are possible. For example, the body molding 700 could be constructed with only the angled ribs 705a and the longitudinal ribs 706apositioned along the top edge 710 as shown, if clip receptacles and corresponding clips, such as those illustratively shown in FIG. 3, were provided. Thus, the body molding 700 may include multiple adhesion areas (e.g., longitudinal ribs 706a and 706b, and angled ribs 705a and 705b) of variable rib density.

The body molding and similar plastic parts of the invention may be molded using any suitable process or technique known to persons of ordinary skill in the art. Exemplary molding techniques currently available include, but are not limited to: blow molding, compression molding, injection molding, and rotary molding. Injection molding may include, but is not limited to, compression injection molding, gas assist injection molding, water assist injection molding, gas counter-pressure injection molding, and other types of injection molding techniques known in the art. Exemplary materials that may be used to form the molding of the invention include, but are not limited to: thermoplastic polyolefins (TPO), acrylonitrate-butadiene-styrene (ABS), polycarbonate (PC), polybutadiene teraphalate (PBT), polyethelene teraphalate (PET), nylon, polyvinyl chloride (PVC), polystrene (PS), blends of the above materials, other suitable materials, and blends of the above materials and other suitable materials. Preferably, all of the features of a given molding, such as the rib patterns, clip attachments, and hangers are integrally formed in the same manufacturing process, but separate formation and attachment of features is certainly possible.

To obtain maximum density and maximum adhesive force, the angled ribs of the invention may be spaced as close as manufacturing techniques will allow. Each rib of the angled ribs may make angles of less than 180° relative to the top (or bottom) edge or longitudinal axis of the molding of the invention. The patterns of angled ribs may be uni-directional, (i.e., all ribs angled at same angle), multi-directional (i.e., a group of ribs angled at one angle and another group of ribs angled at a different angle), or entirely variable or random within each set of ribs or relative to other sets. For example, embodiments of the invention may include one or more series of V-shaped or X-shaped ribs.

Although the above descriptions are directed to various embodiments of the invention, other variations and modifications may be made without departing from the spirit and scope of the invention. For example, features described in connection with one embodiment of the invention may be used in conjunction with other embodiments, even if not explicitly stated above.

1. A body molding adapted to be adhesively secured to a vehicle, said molding comprising:
a body having a longitudinal axis, top and bottom edges, front and back ends, and opposing surfaces; and
a first adhesive receiving area provided on one of said opposing surfaces, said first adhesive receiving area including a first plurality of spaced projections configured to receive an adhesive material, said projections being angled relative to at least one of said longitudinal axis, said top edge and said bottom edge.

2. The body molding of claim 1, further comprising:
a second adhesive receiving area provided on said one opposing surface including a second plurality of spaced projections configured to receive adhesive material.

3. The body molding of claim 2, wherein said first plurality of spaced projections and said second plurality of spaced projections have different spacing and/or orientations such that the densities of projections per unit surface area of said first and second plurality of projections differ, at least of one said densities being selected to enhance the adhesion of adhesive material to said projections.

4. The body molding of claim 2, wherein at least some of said first plurality of projections are angled relative to said second projections.

5. The body molding of claim 2, wherein said second adhesive receiving area is adjacent to said first tape adhesive area.

6. The body molding of claim 5, wherein said first adhesive receiving area is adjacent to said top edge, and said first plurality of spaced projections extends along substantially the entire length of said top edge.

7. The body molding of claim 2, wherein the projections in at least one of said first and second plurality of projections are generally parallel to each other.

8. The body molding of claim 4, wherein said second plurality of projections are substantially parallel to each other and to said longitudinal axis, and said first plurality of projections comprise extensions of said second plurality of projections.

9. The body molding of claim 2, wherein said first adhesive receiving area is located at one of said top and bottom edges, and said second adhesive receiving area is located on said one opposed surface adjacent one of said front and back ends.

10. The body molding of claim 9, wherein said first adhesive receiving area is located adjacent said top edge, said second adhesive receiving area is located adjacent said bottom edge, and further comprising a third adhesive receiving area including a third plurality of spaced projections configured to receive adhesive material, said third adhesive receiving area being located on said one opposed surface adjacent one of said front and back ends.

11. The body molding of claim 10 wherein said first, second and third plurality of projections each include some projections angled relative to at least one of said longitudinal axis, said top edge and said bottom edge.

12. The body molding of claim 9, wherein the first and second adhesive receiving areas extend over less than the entire area of said one opposing surface.

13. The body molding of claim 1, wherein said spaced projections define at least one channel therebetween including an open end allowing fluid trapped in said at least one channel to escape.

14. The body molding of claim 1, wherein said projections comprise a series of thin, closely spaced ribs projecting upwardly from said one opposed surface.

15. The body molding of claim 1, wherein body molding is a side molding of vehicle and the other opposing surface of the molding is an exterior surface capable of having a finish applied thereto.

16. The body molding of claim 15, wherein said first adhesive receiving area comprises an area for receiving adhesive tape, and further comprising double-sided adhesive tape adhered to said first adhesive receiving area, said double-sided tape providing for a secure connection along the top edge of the body side molding to the vehicle.

17. The body molding of claim 1, further comprising a locking member engageable with the vehicle.

18. The body molding of claim 1, wherein said spaced projections and said body are integrally molded in the same molding process.

19. A molded vehicle part having a longitudinal axis, comprising:
opposing surfaces and perimeter edges;
a first adhesion area provided on one of said opposing surfaces for connection to a support surface, said first adhesion area including a first plurality of spaced projections, said projections being angled relative to at least one of the longitudinal axis and one of the perimeter edges of said molded vehicle part.

20. The molded vehicle part of claim 19, further comprising:
a second adhesion area provided on said one opposing surface for connection to a support surface, said second adhesion area including a second plurality of spaced projections.

21. The molded vehicle part of claim 19, wherein said adhesion area is configured to receive double-sided adhesive tape.

22. The molded vehicle part of claim 20, wherein said first plurality of spaced projections and said second plurality of spaced projections have different spacing and/or orientations such that the densities of projections per unit surface area of said first and second plurality of projections differ, at least one of said densities being selected to enhance the adhesion of an adhesive material to said projections.

23. The molded vehicle part of claim 20, further comprising:
a receptacle formed on said one opposing surface;
a locking member having a base portion thereof attached to said receptacle, said locking member including a protrusion engageable in a corresponding receptacle formed in the support surface.

24. A method for manufacturing a plastic vehicle part adapted to receive adhesive material for attaching the part to a surface of the vehicle, said method comprising:
providing a mold capable of producing a plastic vehicle part having a body with a longitudinal axis, top and bottom edges, front and back ends, and opposing surfaces, and a first adhesion area including a first plurality of spaced projections configured to receive adhesive material, with the projections being angled relative to at least one of the longitudinal axis, the top edge, and the bottom edge;
filling said mold with a plastic material;
curing said plastic material to form said plastic vehicle part; and
removing said plastic vehicle part from said mold.

25. The method of claim 24, wherein the plastic material used in said filling step comprises a material selected from the group consisting of: thermoplastic polyolefins (TPO), acrylonitrate-butadiene-styrene (ABS), polycarbonate (PC), polybutadiene teraphalate (PBT), polyethelene teraphalate (PET), nylon, poly vinyl chloride (PVC), polystrene (PS), and combinations thereof.

26. The method of claim 24, further comprising:
washing the plastic vehicle part; and
venting any trapped fluid through openings formed by the spaced projections prior to coating the part.

27. The method of claim 25, further comprising:
adhering the double-sided tape to the first adhesion area.

28. The method of claim 27, further comprising:
attaching a locking member to the plastic vehicle part;
inserting a portion of said locking member into a corresponding receptacle formed in the vehicle and/or attaching the double-sided tape to the vehicle.

29. The method of claim 24, wherein said method steps are performed using a molding technique selected from the group consisting of injection molding, blow molding, compression molding, and spin molding.

30. The method of claim 24, wherein the mold provides a plastic vehicle part further including:
a second adhesive receiving area including a second plurality of spaced projections configured to receive adhesive material, and
wherein the first plurality of spaced projections and second plurality of spaced projections have different orientations such that the densities of projections per unit surface area of the first and second plurality of projections differ, at least one of said densities being selected to enhance the adhesion to the projections.

31. The method of claim 24, wherein the surface of the vehicle comprises at least one of glass, sheet metal, and plastic materials.
